(19) United States
(12) Patent Application Publication
(10) Pub. No.: US 2021/0388999 A1
(43) Pub. Date: Dec. 16, 2021

(54) HYBRID AIR COOLING SYSTEM AND METHOD

(71) Applicant: CRYOGEL, Paris (FR)

(72) Inventor: Christoffel Johannes Vermeulen, Pretoria (ZA)

(73) Assignee: CRYOGEL, Paris (FR)

(21) Appl. No.: 17/426,279

(22) PCT Filed: Jan. 31, 2020
(86) PCT No.: PCT/IB2020/050778

§ 371 Date: Jul. 28, 2021

(30) Foreign Application Priority Data
Jan. 31, 2019 (ZA) 2019/00650

(51) Int. Cl. F24F 5/00; F24F 11/65; F24F 11/83

(52) U.S. Cl. CPC F24F 5/0035; F24F 5/0021; F24F 2110/22; F24F 11/83; F24F 11/65

(57) ABSTRACT

This invention relates to a hybrid air cooling system 10 comprising a primary inlet 12 for receiving a primary air stream 14, a primary outlet 16 for supplying a conditioned air stream 18 to a conditioned space, and a primary air flow passage 20 extending between the primary inlet and outlet 12, 16. The system 10 further comprises a primary heat exchange means 22, disposed in the primary air flow passage 20, which is adapted to permit the primary air stream 14 to operatively pass therethrough, to extract heat energy from the primary air stream 14 as it passes therethrough and thereby form the conditioned air stream 18. The primary heat exchange means 22 includes a first indirect heat exchange element 24 utilising a first coolant 26 for extracting the heat energy from the primary air stream 14, a second indirect heat exchange element 28 utilising a second coolant 30 for extracting the heat energy from the primary air stream 14, and a third direct heat exchange element 32 utilising a third coolant 34 for extracting the heat energy from the primary air stream 14.

### FIELD OF THE INVENTION

This invention relates to a hybrid air cooling system and method. More specifically, but not exclusively, this invention relates to a hybrid air cooling system and method that is able to adjust its operating state depending on the prevailing atmospheric conditions.

### BACKGROUND TO THE INVENTION

Hybrid air cooling systems comprising an evaporative cooling unit, which relies on the evaporation of a liquid to cool a medium, and a refrigeration cooling unit, which relies on a sequence of thermodynamic processes whereby heat is withdrawn from a cold medium and expelled to a hot medium, are well known and widely used.

In comparison to refrigeration cooling units, evaporative cooling units consume significantly less electricity during their operation and are therefore more economical to operate. However, since the working of evaporative cooling relies on the evaporation of liquid, they operate ineffectively in humid conditions.

For the aforementioned reasons, the respective cooling units are often installed together, especially where the temperature of a large area needs to be regulated, so as to utilise the operational benefits of both types of cooling units. In accordance with this configuration, the evaporative cooling unit is primarily relied upon for supplying cold air to a designated area, and the refrigeration cooling unit is only utilised for the supply of cold air when the evaporative cooling unit is unable to adequately do so due to, typically, unfavourable atmospheric conditions.

A drawback associated with the aforementioned hybrid air cooling system is that its electricity consumption increases significantly when the refrigeration cooling unit is in operation. It is well known for consumers to be charged by electricity service providers not only according to their total electricity consumption for a particular period of time (often measured in kilowatt-hour), but also according to the peak load that was utilised during the same period irrespective of the duration the peak load was required. The refrigeration cooling unit is the main contributor to the peak load usage of the cooling system.

### OBJECT OF THE INVENTION

It is accordingly an object of the present invention to provide a hybrid air cooling system and method with which the above disadvantage could be overcome, or at least be reduced, and/or that would be a useful alternative to known hybrid air cooling systems and methods.

### SUMMARY OF THE INVENTION

According to a first aspect of the invention, there is provided a hybrid air cooling system comprising:
a primary inlet for receiving a primary air stream, a primary outlet for supplying a conditioned air stream to a conditioned space, and a primary air flow passage extending between the primary inlet and outlet;
primary heat exchange means, disposed in the primary air flow passage, and adapted to permit the primary air stream to operatively pass therethrough, the primary heat exchange means operable to extract heat energy from the primary air stream as it passes therethrough and thereby form the conditioned air stream from the primary air stream, the primary heat exchange means including:
   a first indirect heat exchange element operatively utilising a first coolant to extract the heat energy from the primary air stream;
   a second indirect heat exchange element operatively utilising a second coolant to extract the heat energy from the primary air stream; and
   a third direct heat exchange element operatively utilising a third coolant to extract the heat energy from the primary air stream;
an evaporative cooling unit for extracting heat energy from the first coolant by means of evaporation before it is operatively supplied to the first indirect heat exchange element;
a thermal energy storage reservoir for absorbing heat energy from the second coolant before it is operatively supplied to the second indirect heat exchange element; and
primary coolant distribution means for distributing the third coolant over the third direct heat exchange element, whereby heat energy is operatively extracted from the primary air stream as it comes into contact with the third coolant and moisture from the third coolant is absorbed into the primary air stream.

It will be appreciated that the hybrid air cooling system may be configured to operatively, at a particular point in time, cool the primary air stream by extracting heat energy from it by means of any one or more selected from the group comprising the first indirect heat exchange element, second indirect heat exchange element and third direct heat exchange element.

According to an example embodiment of the invention, the hybrid air cooling system may be configured to, during first atmospheric conditions, operatively cool the primary air stream by extracting heat energy from it by means of any one or both of the first and third heat exchange elements, and to, during second atmospheric conditions, whereby the first and third heat exchange elements are unable to cool the primary air stream to a desired setpoint temperature, operatively cool the primary air stream by extracting heat energy from it by means of the second indirect heat exchange element.

Heat energy may be extracted from the primary air stream by the second indirect heat exchange element either in conjunction with any one or both of the first and third heat exchange elements, or separately from any one or both of the first and third heat exchange elements.

There is provided for the first atmospheric conditions to be more conducive for evaporative cooling than the second atmospheric conditions. More specifically, air at the first atmospheric conditions has a lower relative humidity than air at the second atmospheric conditions. The wet bulb depression is therefore larger at the first atmospheric condition than at the second atmospheric condition, and is the largest contributing factor to the efficiency of the system.

A primary coolant reservoir may be provided underneath the primary heat exchange means for receiving and accumulating the third coolant flowing from the third direct heat exchange element. According to an example embodiment, the system is configured to operatively supply the third coolant from the primary coolant reservoir to the primary coolant distribution means.

The primary coolant distribution means may include a primary manifold located at an operatively upper end of the third direct heat exchange element.

There is provided for the evaporative cooling unit to comprise:
a secondary inlet for receiving a secondary air stream, a secondary outlet for discharging an exhaust air stream from the cooling unit, and a secondary air flow passage extending between the secondary inlet and outlet;
a secondary direct heat exchange element, disposed in the secondary air flow passage and adapted to permit the secondary air stream to operatively pass therethrough; and
secondary coolant distribution means for distributing the first coolant over the secondary direct heat exchange element, whereby heat energy is operatively extracted from the first coolant as it comes into contact with the secondary air stream and moisture from it is absorbed into the secondary air stream.

A secondary coolant reservoir may be provided underneath the secondary direct heat exchange element for operatively receiving and accumulating the first coolant flowing from the secondary direct heat exchange element.

The secondary coolant distribution means may include a secondary manifold located above the secondary direct heat exchange element.

There is provided for the first indirect heat exchange element to comprise a length of piping operatively through which the first coolant flows and over which the primary air stream passes, whereby the heat energy is transferred from the primary air stream to the first coolant.

Preferably, the system is configured such that the first coolant is operatively supplied from the secondary coolant reservoir to the first indirect heat exchange element where heat energy is transferred from the primary air stream to the first coolant and further configured to subsequently have the first coolant returned from the first indirect heat exchange element to the secondary coolant distribution means.

The system may further include a heat transfer device for receiving the second coolant and operable to transfer heat energy from the second coolant to a heat sink. According to an example embodiment of the invention, the heat transfer device is in the form of a heat pump and the heat sink is atmospheric air.

The system may be configured to operatively supply the second coolant from the heat transfer device to the thermal energy storage reservoir, where the second coolant absorbs heat energy from the thermal energy storage reservoir, and to subsequently return the second coolant to the heat transfer device.

The thermal energy storage reservoir may comprise:
an enclosure in which a plurality of thermal energy storage elements is stacked, each element having an outer shell which is formed of a flexible material and filled with a thermal energy storage medium; and
storage coolant distribution means for distributing the second coolant over the thermal energy storage elements whereby heat energy is operatively able to transfer between the second coolant and the thermal energy storage elements as the second coolant flows over and comes into contact with the thermal energy storage elements.

There is provided for the second indirect heat exchange element to comprise a length of piping operatively through which the second coolant flows and over which the primary air stream passes, whereby the heat energy is transferred from the primary air stream to the second coolant.

The system is configured such that, according to a first example operating state thereof, the second coolant is operatively supplied from the thermal energy storage reservoir to the second indirect heat exchange element, where heat energy is transferred from the primary air stream to the second coolant. The second coolant is subsequently returned from the second indirect heat exchange element to the thermal energy storage reservoir where heat energy is transferred from the second coolant to the thermal energy storage reservoir. More specifically, heat energy is transferred from the second coolant to the thermal energy storage elements as they come into contact with each other.

Preferably, the second coolant is operatively supplied from a base region of the enclosure to the second indirect heat exchange element and after heat energy is transferred from the primary air stream to the second coolant, the second coolant is returned from the second indirect heat exchange element to the reservoir

The system is configured such that, according to a second example operating state thereof, the second coolant is operatively supplied from the thermal energy storage reservoir to the heat transfer device where heat energy is rejected from the second coolant to the heat sink. The second coolant is subsequently returned from the heat transfer device to the thermal energy storage reservoir where heat energy is transferred from the reservoir to the second coolant. More specifically, heat energy is transferred from the thermal energy storage elements to the second coolant as they come into contact with each other.

Preferably, the thermal energy storage medium of the thermal energy storage elements comprises a phase changing medium, such as water.

There is provided for the first, second and third heat exchange elements to be located in series, whereby the primary air stream operatively passes through each of the first, second and third heat exchange elements as it moves from the primary inlet to the primary outlet.

A primary blower may be located in the primary air flow passage for inducing the primary air stream.

A secondary blower may be located in the secondary air flow passage for inducing the secondary air stream.

According to an example embodiment of the invention, the primary inlet, outlet, air flow passage, and heat exchange means may collectively form a primary cooling unit. The primary cooling unit may be integrally connected to the evaporative cooling unit.

The first and third coolants may comprise water. The second coolant may comprise water with an additional agent, such as an antifreeze agent that reduces the freezing point temperature of the second coolant.

According to a second aspect of the invention, there is provided a method of supplying a conditioned air stream to a conditioned space, the method including the steps of, under first atmospheric conditions:
extracting heat energy from a first coolant by means of evaporation;
supplying the first coolant to a first indirect heat exchange element;
distributing a third coolant over a third direct heat exchange element; and
forcing a primary air stream through the first and third heat exchange elements, whereby heat energy is transferred from the air stream to the first coolant as the air stream passes through the first heat exchange element, and further whereby heat energy is extracted from the air stream as it comes into contact with the third coolant and moisture from the third coolant is absorbed into the air stream, to consequently form the conditioned air stream from the primary air stream;

and under second atmospheric conditions:
transferring heat energy from a second coolant to a thermal energy storage reservoir by bringing the second coolant in the proximity of the reservoir, which is maintained at a lower operating temperature than the second coolant;
supplying the second coolant to a second indirect heat exchange element; and
forcing the primary air stream through the second heat exchange element, whereby heat energy is transferred from the air stream to the second coolant as it passes through the second heat exchange element, to consequently form the conditioned air stream from the primary air stream.

Under second atmospheric conditions, the first and third heat exchange elements may be unable to cool the primary air stream to a desired setpoint temperature.

The method further provides for, under second atmospheric conditions:
extracting heat energy from the first coolant by means of evaporation;
supplying the first coolant to the first indirect heat exchange element; and
forcing the primary air stream through the first heat exchange element, whereby heat energy is transferred from the air stream to the first coolant as the air stream passes through the first heat exchange element.

The method also provides for, under second atmospheric conditions:
distributing the third coolant over the third direct heat exchange element;
forcing the primary air stream through the third heat exchange element, whereby heat energy is extracted from the air stream as it comes into contact with the third coolant and moisture from the third coolant is absorbed into the air stream.

There is also provided for the transferal of heat energy from the second coolant to a heat sink. According to an example embodiment of the invention, the heat transfer device is in the form of a heat pump and the heat sink is atmospheric air.

There is provided for the first atmospheric conditions to be more conducive for evaporative cooling than the second atmospheric conditions. More specifically, air at the first atmospheric conditions has a lower relative humidity than air at the second atmospheric conditions. The wet bulb depression is therefore larger at the first atmospheric condition than at the second atmospheric condition, and is the largest contributing factor to the efficiency of the system.

These and other features of the invention are described in more detail below.

### BRIEF DESCRIPTION OF THE ACCOMPANYING DIAGRAMS

One embodiment of the invention is described below, by way of a non-limiting example only and with reference to the accompanying drawings in which:

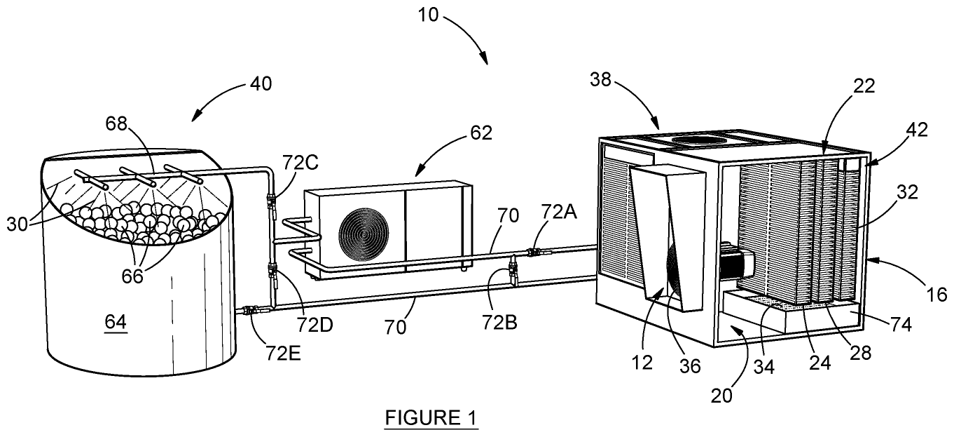

FIG. 1 is a schematic cutaway perspective front view of a hybrid air cooling system in accordance with the invention;

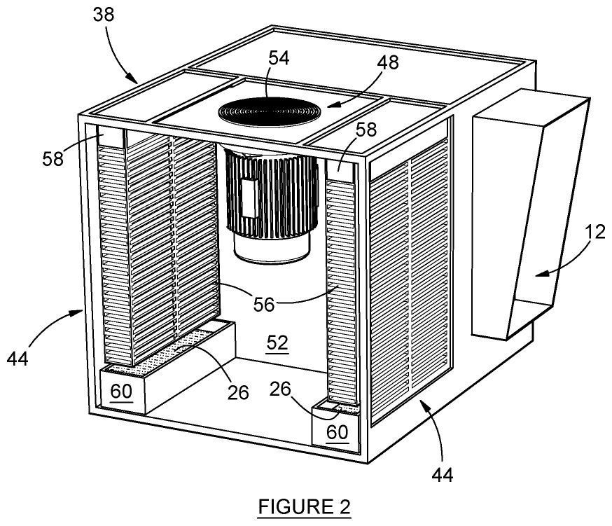

FIG. 2 is a schematic cutaway perspective rear view of a main cooling unit that forms part of the system of FIG. 1;

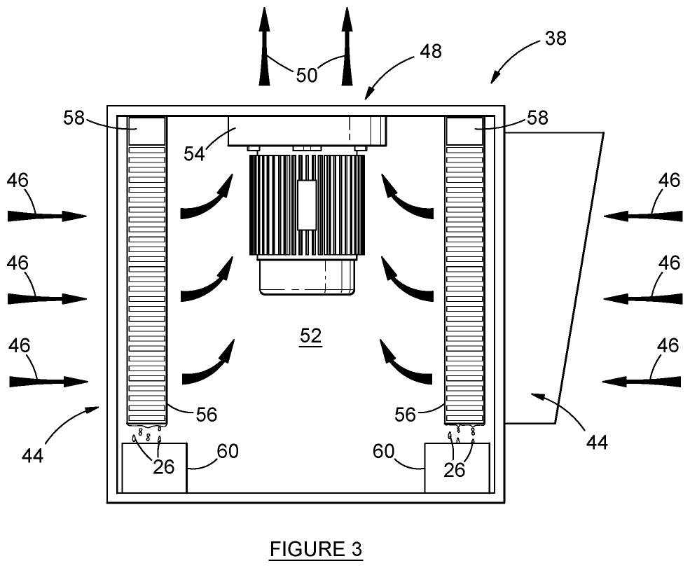

FIG. 3 is a schematic rear view of the main cooling unit, in use; and

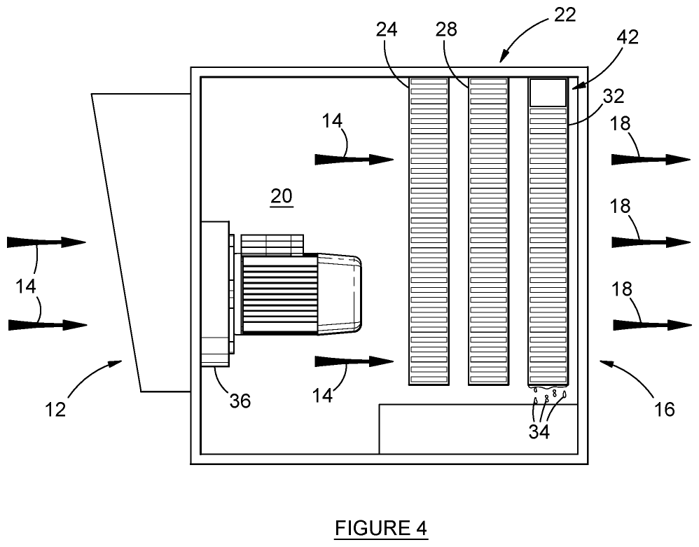

FIG. 4 is a schematic front view of the main cooling unit, in use.

### DETAILED DESCRIPTION OF AN EXAMPLE EMBODIMENT OF THE INVENTION

With reference to the drawings, in which like numerals refer to like features, a hybrid air cooling system, in accordance with the invention, is designated generally by reference numeral 10 in FIG. 1.

The system 10 comprises a primary inlet 12 for receiving a primary air stream 14 (see FIG. 4), a primary outlet 16 for supplying a conditioned air stream 18 to a conditioned space (not shown), and a primary air flow passage 20 extending between the primary inlet and outlet 12, 16.

The system 10 further comprises a primary heat exchange means 22, disposed in the primary air flow passage 20. The primary heat exchange means 22 is adapted to permit the primary air stream 14 to operatively pass therethrough, to extract heat energy from the primary air stream 14 as it passes therethrough and thereby form the conditioned air stream 18. The primary heat exchange means 22 includes a first indirect heat exchange element 24 utilising a first coolant 26 for extracting the heat energy from the primary air stream 14, a second indirect heat exchange element 28 utilising a second coolant 30 for extracting the heat energy from the primary air stream 14, and a third direct heat exchange element 32 utilising a third coolant 34 for extracting the heat energy from the primary air stream 14. During the cooling phases, whereby the primary aft stream 14 passes through the first and second indirect heat exchange elements 24, 28, it doesn't absorb any extra moisture, and during the cooling phase whereby the primary air stream 14 passes through the third direct heat exchange element 32, it absorbs some additional moisture. This is due to the fact that when the primary air stream 14 operatively passes through the first and second indirect heat exchange elements 24, 28, the primary air stream 14 does not come into contact with the first and second coolants 26, 30, but when it operatively passes through the third heat exchange element 32, the primary air stream 14 does come into contact with the third coolant 34.

According to the example embodiment of the invention shown, the first, second and third heat exchange elements 24, 28, 32 are located in series, whereby the primary air stream 14 operatively passes through each of these heat exchange elements 24, 28, 32 as it moves from the primary inlet 12 to the primary outlet 16. A primary air blower 36, which is located in the primary air flow passage 20, operatively induces the primary air stream 14.

The system 10 also includes an evaporative cooling unit 38, which extracts heat energy from the first coolant 26 by means of evaporation before it is operatively supplied to the first indirect heat exchange element 24. The system 10 includes a thermal energy storage reservoir 40, that is operable to absorb heat energy from the second coolant 30 before it is operatively supplied to the second indirect heat exchange element 28.

The system 10 further includes primary coolant distribution means 42 for distributing the third coolant 34 over the third direct heat exchange element 32, whereby heat energy is operatively extracted from the primary air stream 14 as it comes into contact with the third coolant 34 and moisture from the third coolant 34 is operatively absorbed into the primary air stream 14.

The primary inlet 12, outlet 16, air flow passage 20, and heat exchange means 22 collectively form a primary cooling unit. Preferably, the primary cooling unit is integrally connected to the evaporative cooling unit 38.

The system 10 is configured to, during first atmospheric conditions, to operatively cool the primary air stream 14 by extracting heat energy from it by means of the first and third heat exchange elements 24, 32 only, and to, during second atmospheric conditions, whereby the first and third heat exchange elements 24, 32 are unable to cool the primary air stream 14 to a desired setpoint temperature, to operatively cool the primary air stream 14 by extracting heat energy from it by means of the second indirect heat exchange element 28. The first atmospheric conditions are more conducive for evaporative cooling than the second atmospheric conditions. The wet bulb depression, which is the largest contributing factor to the efficiency of the unit, is, therefore, larger in the first atmospheric condition than in the second atmospheric condition which requires heat energy to be extracted by means of the first and third heat exchange elements 24, 32 as well as the second indirect heat exchange element 28. It is envisaged that the second heat exchange element 28 may be operated separate or in conjunction with the first and third heat exchange elements 24, 32, depending on the operating requirements.

Turning to FIGS. 2 and 3, the evaporative cooling unit 38 comprises a secondary inlet 44, in this example embodiment being two opposing secondary inlets 44, for receiving a secondary air stream 46, a secondary outlet 48 for discharging an exhaust air stream 50 from the cooling unit 38, and a secondary air flow passage 52 extending between the secondary inlet 44 and secondary outlet 48. A secondary air blower 54, located in the secondary air flow passage 52, operatively induces the secondary air stream 46.

The evaporative cooling unit 38 also includes a secondary direct heat exchange element 56, in this example embodiment being two opposing heat exchange elements 56, each of which is located adjacent to one of the secondary inlets 44, disposed in the secondary air flow passage 52 and adapted to permit the secondary air stream 46 to operatively pass therethrough.

A secondary coolant distribution means 58, in the form of a secondary manifold, for distributing the first coolant over each of the secondary direct heat exchange elements 56, is located above each of the elements 56. Heat energy is operatively extracted from the first coolant 26 by way of evaporative cooling as it comes into contact with the secondary air stream 46 and moisture from the first coolant 26 is absorbed into the secondary air stream 46. Heat energy needs to be applied to the first coolant 26 to change it from a liquid to a vapor, the heat is lost from the first coolant 26, which causes cooling of the first coolant 26, when the phase change occurs.

As shown, a secondary coolant reservoir 60 is located underneath each of the secondary heat exchange elements 56 for operatively receiving and accumulating the cooled first coolant 26, flowing from the secondary direct heat exchange elements 56. The first coolant 26 is operatively supplied, typically by means of at least one liquid circulating pump and associated piping (not shown) from the secondary coolant reservoirs 60 through the first indirect heat exchange element 24 and to the secondary coolant distribution means 58.

The first indirect heat exchange element 24 comprises a length of piping operatively through which the first coolant 26 flows and over which the primary air stream 14 passes, whereby the heat energy is transferred from the primary air stream 14 to the first coolant 26, to thereby cool the primary air stream 14. The first coolant 26 is operatively supplied from the secondary coolant reservoirs 60 to the first indirect heat exchange element 24, where the heat energy is transferred from the primary air stream 14 to the first coolant 26, and subsequently returned from the first indirect heat exchange element 24 to the secondary coolant distribution means 58, and subsequently the secondary direct heat exchange elements 56, for cooling.

A heat transfer device 62 is provided for transferring heat energy from the second coolant 30 to a heat sink. In this example embodiment of the invention, the heat transfer device 62 is in the form of a heat pump and the heat sink is atmospheric air.

The thermal energy storage reservoir 40 comprises an insulated enclosure 64 in which a plurality of thermal energy storage elements 66 are stacked, each element 66 having an outer shell which is formed of a flexible material and filled with a thermal energy storage medium (not shown) in the form of a phase changing medium, such as water. The reservoir 40 also comprises a storage coolant distribution means 68, in the form of a storage manifold, for distributing the second coolant 30 over the thermal energy storage elements 66 whereby heat energy is operatively permitted to transfer between the second coolant 30 and the thermal energy storage elements 66 as the second coolant 30 flows over the thermal energy storage elements 66.

The second indirect heat exchange element 28 comprises a length of piping operatively through which the second coolant 30 flows and over which the primary air stream 14 passes, whereby the heat energy is transferred from the primary air stream 14 to the second coolant 30.

According to a first example operating state of the system 10, whereby it is required for heat energy to be extracted from the primary air stream 14 by means of the second indirect heat exchange element 28 in order to cool the air stream 14 to a desired set point temperature, the second coolant 30 is operatively supplied from, for example, a lower base region of the thermal energy storage reservoir 40 to the second indirect heat exchange element 28 by means of conduits 70. In order to accomplish same, valves 72A, 72C, and 72E which are mounted on the conduits 70 need to be in an open configuration whereby the second coolant 30 is permitted to operatively pass through them, and valves 72B and 72D which are also mounted on the conduits 70 need to be in a closed configuration whereby the second coolant 30 is prevented from operatively passing through them.

At the second indirect heat exchange element 28, heat energy is transferred from the primary air stream 14 to the second coolant 30, which is subsequently returned from the second indirect heat exchange element 28 to the thermal energy storage reservoir 40, via the storage coolant distribution means 68, where heat energy is transferred from the second coolant 30 to the reservoir 40. More specifically, heat energy is transferred from the second coolant 30 to the thermal energy storage elements 66 as they come into contact with each other.

Furthermore, according to a second example operating state of the system 10, whereby it is not required for heat energy to be extracted from the primary air stream 14 by means of the second indirect heat exchange element 28 in order to cool the air stream 14 to a desired set point temperature, and the thermal energy storage elements 66 need to be cooled (charged), the second coolant 30 is operatively supplied from (the lower base region of) the thermal energy storage reservoir 40 to the heat transfer device 62 by means of the conduits 70. In order to accomplish same, the valves 72A and 72D need to be in a closed configuration whereby the second coolant 30 is prevented from operatively passing through them and accordingly through the second indirect heat exchange element 28, and valves 72B, 72C, and 72E need to be in an open configuration whereby the second coolant 30 is permitted to operatively pass through them.

At the heat exchange device 62, heat energy is rejected from the second coolant 30 to the heat sink, and the second coolant 30 is subsequently returned from the heat transfer device 62 to the thermal energy storage reservoir 40, via the storage coolant distribution means 68, where heat energy is transferred from the reservoir 40 to the second coolant 30. More specifically, heat energy is transferred from the thermal energy storage elements 66 to the second coolant 30 as they come into contact with each other.

Also, according to a third example operating state of the system 10, whereby the temperature of the ambient air is lower than the desired temperature of the conditioned space, heat energy needs to be added to the primary air stream 14 by means of the second indirect heat exchange element 28 in order to heat the air stream 14 to a desired set point temperature. The second coolant 30 is operatively supplied from the second indirect heat exchange element 28 to the heat transfer device 62 by means of conduits 70. In order to accomplish same, the valves 72B, 72C, and 72E need to be in a closed configuration whereby the second coolant 30 is prevented from operatively passing through, and valves 72A and 72D need to be in an open configuration whereby the second coolant 30 is permitted to operatively pass through them.

At the heat exchange device 62, heat energy is transferred to the second coolant 30, and the coolant 30 is subsequently returned from the heat transfer device 62 to the second indirect heat exchange element 28, where heat energy is transferred from the second coolant 30 to the air stream 14.

A primary coolant reservoir 74 is provided underneath the primary heat exchange means 22 for operatively receiving and accumulating the third coolant 34 flowing from the third direct heat exchange element 32, as well as any condensation that flows down the first and second indirect heat exchange elements 24, 28. The third coolant 34 is operatively supplied, typically by means of a liquid circulating pump and associated piping (not shown) from the primary coolant reservoir 74 to the primary coolant distribution means 42, which is in the form of a primary manifold located at the operatively upper end of the third direct heat exchange element 32.

The applicant believes that the invention provides an effective solution for significantly reducing the peak load electricity usage of the hybrid air cooling system irrespective of its operating state based on atmospheric conditions. More specifically, during (humid) atmospheric conditions which are unfavourable to evaporative cooling, cooling means in the form of the thermal energy storage reservoir 40 could be utilised for cooling purposes, thus negating the need for a refrigerant-based cooling unit that consumes significantly more electricity than an equivalent evaporative cooling unit. Furthermore, heat energy could, for example, be extracted from the thermal energy storage reservoir 40 at times when the demand for electricity is low, such at night, and when, in some instances, the electricity prices are also lower. Thus, when it may be required for heat energy to be transferred from the primary air stream 14, via the second coolant 30, to the thermal energy storage reservoir 40, the reservoir 40 is at a low operating temperature and capable of absorbing heat energy, from the second coolant 30, for an extended period of time.

It will be appreciated by those skilled in the art that the invention is not limited to the precise details as described herein and that many variations are possible without departing from the scope and spirit of the invention. For example, it is envisaged that during second atmospheric conditions, the first and third heat exchange elements 24, 32 could be operatively utilised in conjunction with the second heat exchange element 28 to extract heat energy from the primary air stream 14. Similarly, during first atmospheric conditions, second heat exchange element 28 could be operatively utilised in conjunction with the first and third heat exchange elements 24 to extract heat energy from the primary air stream 14. Also, any one of the heat exchange elements 24, 28, and 32 could be operatively utilised either on its own, or in conjunction with any one or more of the remaining heat exchange elements 24, 28, and 32 to extract heat energy from the primary air stream 14. Also, in an example embodiment of the invention, the system 10 may include a liquid inlet (not shown) for receiving the first coolant 26 from an external source (not shown), such as for example, an underground water reservoir, either in addition to, or instead of the evaporative cooling unit 38, which is subsequently supplied to the first heat exchange element 24, which coolant 26 may thereafter be returned to the external source. It is also envisaged that in a further embodiment of the invention, any one or more of the evaporative cooling unit 38, pipes 70, heat transfer device 62 and thermal energy storage reservoir 40, and any one or more of their associated components, could be omitted and for the system 10 to include a liquid inlet (not shown) for receiving the first coolant 26 from an external source (not shown), such as for example, an underground water reservoir, either in addition to, or instead of the evaporative cooling unit 38, which is subsequently supplied to the first heat exchange element 24, which coolant 26 may thereafter be returned to the external source

The description is presented in the cause of providing what is believed to be the most useful and readily understood description of the principles and conceptual aspects of the invention. In this regard, no attempt is made to show structural details of the invention in more detail than is necessary for a fundamental understanding of the invention.

1-26. (canceled)

27. A hybrid air cooling system comprising:
a primary inlet for receiving a primary air stream, a primary outlet for supplying a conditioned air stream to a conditioned space, and a primary air flow passage extending between the primary inlet and outlet;
a primary heat exchange arrangement, disposed in the primary air flow passage, and adapted to permit the primary air stream to operatively pass therethrough, the primary heat exchange arrangement being operable to extract heat energy from the primary air stream as it passes therethrough and thereby form the conditioned air stream from the primary air stream, the primary heat exchange arrangement including:
a first indirect heat exchange element operatively utilising a first coolant to extract the heat energy from the primary air stream;
a second indirect heat exchange element operatively utilising a second coolant to extract the heat energy from the primary air stream; and
a third direct heat exchange element operatively utilising a third coolant to extract the heat energy from the primary air stream;
an evaporative cooling unit operable to extract heat energy from the first coolant by means of evaporation before the first coolant is supplied to the first indirect heat exchange element; and
a primary coolant distribution arrangement operable to distribute the third coolant over the third direct heat exchange element, whereby heat energy is extracted from the primary air stream as it comes into contact with the third coolant and moisture from the third coolant is absorbed into the primary air stream, characterised in that the hybrid air cooling system further comprises a thermal energy storage reservoir operable to absorb heat energy from the second coolant) before the second coolant is supplied to the second indirect heat exchange element.

28. The hybrid air cooling system as claimed in claim 27, configured to operatively supply the second coolant from the thermal energy storage reservoir to the second indirect heat exchange element to permit heat energy to be transferred from the primary air stream to the second coolant, and further configured to subsequently return the second coolant to the thermal energy storage reservoir to permit heat energy to be transferred from the second coolant to the thermal energy storage reservoir.

29. The hybrid air cooling system as claimed in claim 27, configured to operatively cool the primary air stream by extracting heat energy from it by means of any one or more selected from the group comprising the first indirect heat exchange element, second indirect heat exchange element and third direct heat exchange element.

30. The hybrid air cooling system as claimed in claim 27, configured to, during first atmospheric conditions, operatively cool the primary air stream by extracting heat energy from the primary air stream by means of any one or both of the first and third heat exchange elements.

31. The hybrid air cooling system as claimed in claim 30, configured to, during second atmospheric conditions which has a higher relative humidity than the first atmospheric conditions, operatively cool the primary air stream by extracting heat energy from the primary air stream by means of the second heat exchange element.

32. The hybrid air cooling system as claimed in claim 31, configured to, during second atmospheric conditions, operatively cool the primary air stream by extracting heat energy from the primary air stream by means of any one or both of the first and third heat exchange elements.

33. The hybrid air cooling system as claimed in claim 27, wherein the evaporative cooling unit comprises:
a secondary inlet for receiving a secondary air stream, a secondary outlet for discharging an exhaust air stream from the cooling unit, and a secondary air flow passage extending between the secondary inlet and secondary outlet;
a secondary direct heat exchange element disposed in the secondary air flow passage and adapted to permit the secondary air stream to operatively pass therethrough; and
a secondary coolant distribution arrangement for distributing the first coolant over the secondary direct heat exchange element, whereby heat energy is operatively extracted from the first coolant as it comes into contact with the secondary air stream and moisture from it is absorbed into the secondary air stream.

34. The hybrid air cooling system as claimed in claim 33, wherein a secondary coolant reservoir is provided underneath the secondary direct heat exchange element for operatively receiving and accumulating the first coolant flowing from the secondary direct heat exchange element, and the system
configured to operatively supply the first coolant from the secondary coolant reservoir to the first indirect heat exchange element to permit heat energy to be transferred from the primary air stream to the first coolant, and further configured to subsequently return the first coolant from the first indirect heat exchange element to the secondary coolant distribution arrangement.

35. The hybrid air cooling system as claimed in claim 27, including a heat transfer device for receiving the second coolant and operable to transfer heat energy from the second coolant to a heat sink.

36. The hybrid air cooling system as claimed in claim 35, wherein the heat transfer device is in the form of a heat pump and the heat sink is atmospheric air.

37. The hybrid air cooling system as claimed in claim 35, configured to operatively supply the second coolant from the heat transfer device to the thermal energy storage reservoir, to permit the second coolant to absorb heat energy from the thermal energy storage reservoir, and to subsequently return the second coolant to the heat transfer device.

38. The hybrid air cooling system as claimed in claim 27, wherein the thermal energy storage reservoir comprises:
an enclosure in which a plurality of thermal energy storage elements is stacked, each element having an outer shell which is formed of a flexible material and filled with a thermal energy storage medium; and
a storage coolant distribution arrangement for distributing the second coolant over the thermal energy storage elements whereby heat energy is operatively transferred between the second coolant and the thermal energy storage elements as the second coolant flows over and comes into contact with the thermal energy storage elements.

39. The hybrid air cooling system as claimed in claim 38, wherein the thermal energy storage medium comprises a phase changing medium.

40. The hybrid air cooling system as claimed in claim 27, wherein the first, second and third heat exchange elements are located in series, whereby the primary air stream operatively passes through each of the first, second and third heat exchange elements as it moves from the primary inlet to the primary outlet.

41. A method of supplying a conditioned air stream to a conditioned space, the method including the steps of, under first atmospheric conditions:
extracting heat energy from a first coolant by means of evaporation;
supplying the first coolant to a first indirect heat exchange element;
distributing a third coolant over a third direct heat exchange element; and
forcing a primary air stream through the first and third heat exchange elements, whereby heat energy is transferred from the primary air stream to the first coolant as the primary air stream passes through the first indirect heat exchange element, and further whereby heat energy is extracted from the primary air stream as it comes into contact with the third coolant and moisture from the third coolant is absorbed into the primary air stream, to consequently form the conditioned air stream from the primary air stream;
characterised in that the method further includes, under second atmospheric conditions:
transferring heat energy from a second coolant to a thermal energy storage reservoir by bringing the second coolant in the proximity of the thermal energy storage reservoir which is maintained at a lower operating temperature than the second coolant;
supplying the second coolant to a second indirect heat exchange element; and
forcing the primary air stream through the second heat exchange element, whereby heat energy is transferred from the primary air stream to the second coolant as it passes through the second heat exchange element, to consequently form the conditioned air stream from the primary air stream.

42. The method as claimed in claim 41, including, under second atmospheric conditions:
extracting heat energy from the first coolant by means of evaporation;
supplying the first coolant to the first indirect heat exchange element; and
forcing the primary air stream through the first heat exchange element, whereby heat energy is transferred from the air stream to the first coolant as the air stream passes through the first heat exchange element.

43. The method as claimed in claim 41, including, under second atmospheric conditions:
distributing the third coolant over the third direct heat exchange element; and
forcing the primary air stream through the third heat exchange element, whereby heat energy is extracted from the air stream as it comes into contact with the third coolant and moisture from the third coolant is absorbed into the air stream.

44. The method as claimed in claim 41, wherein heat energy is transferred from the second coolant to a heat sink.

45. The method as claimed in claim 41, wherein the first atmospheric condition is more conducive for evaporative cooling than the second atmospheric conditions, and air at the first atmospheric condition has a lower relative humidity than air at the second atmospheric conditions.
